(19) United States
(12) Patent Application Publication
(10) Pub. No.: US 2023/0231179 A1
(43) Pub. Date: Jul. 20, 2023

(54) NEGATIVE ELECTRODE FOR RECHARGEABLE LITHIUM BATTERY AND RECHARGEABLE LITHIUM BATTERY INCLUDING SAME

(71) Applicant: SAMSUNG SDI CO., LTD., Yongin-si (KR)

(72) Inventor: Fumiko KIMURA, Yongin-si (KR)

(21) Appl. No.: 18/153,907

(22) Filed: Jan. 12, 2023

(30) Foreign Application Priority Data
Jan. 14, 2022 (KR) 10-2022-0006146

(51) Int. Cl. H01M 10/0525; H01M 50/46

(52) U.S. Cl. CPC H01M 10/0525; H01M 50/461; H01M 2004/027

(57) ABSTRACT

A negative electrode for a rechargeable lithium and a rechargeable lithium battery, and the negative electrode includes a current collector and a negative active material layer positioned on the current collector, wherein the negative active material layer includes a plurality of holes at a hole density of about 90 pt/mm² or more.

### CROSS-REFERENCE TO RELATED APPLICATION

This application claims priority to and the benefit of Korean Patent Application No. 10-2022-0006146, filed in the Korean Intellectual Property Office on Jan. 14, 2022, the entire content of which is incorporated herein by reference.

### BACKGROUND

### 1. Field

Embodiments of the present disclosure described herein are related to a negative electrode for a rechargeable lithium battery and a rechargeable lithium battery including the same.

### 2. Description of the Related Art

Recently, the rapid development of electronic devices (such as mobile phones, laptop computers, and/or electric vehicles), utilizing batteries, results in surprising increases in demands for rechargeable batteries with relatively high capacity and lighter weight. For example, a rechargeable lithium battery has recently drawn attention as a driving power source for portable devices, as it has relatively lighter weight and higher energy density.

A rechargeable lithium battery includes a positive electrode and a negative electrode (which may include an active material being capable of intercalating and deintercalating lithium ions), and an electrolyte, and generates electrical energy due to an oxidation and reduction reaction when lithium ions are intercalated and deintercalated into the positive electrode and the negative electrode.

As for a positive active material of a rechargeable lithium battery, transition metal compounds such as lithium cobalt oxides, lithium nickel oxides, and/or lithium manganese oxide are mainly utilized. As the negative active material, a crystalline carbonaceous material such as natural graphite or artificial graphite, or an amorphous carbonaceous material, is utilized.

The thick and high-density layer formation is essential for increasing energy to the rechargeable lithium battery. Furthermore, it is necessary to inhibit swelling and shape deformation due to contraction and expansion during charging and discharging in order to solve rapid deterioration of the cycle-life characteristics.

For this purpose, attempts have been made to study a structure of the battery having an adhesion function to the interface between the electrode and the separator. However, an adhesive polymer for imparting the adhesion is inserted into the micropores on the surface of the active material layer, thereby reducing lithium ion paths and increase resistance.

The above information disclosed in this Background section is only for enhancement of understanding of the background of the present disclosure, and therefore it may contain information that does not form the prior art that is already known in this country to a person of ordinary skill in the art.

### SUMMARY

An aspect of one or more embodiments of the present disclosure is directed toward a negative electrode for a rechargeable lithium battery exhibiting high energy density and excellent or suitable high-rate charge and discharge characteristics.

An aspect of one or more embodiments of the present disclosure is directed toward a rechargeable lithium battery including a negative electrode.

Additional aspects will be set forth in part in the description which follows and, in part, will be apparent from the description, or may be learned by practice of the presented embodiments of the disclosure.

According to one or more embodiments, a negative electrode for a rechargeable lithium battery includes a current collector; and a negative active material layer positioned on the current collector, and the negative active material layer includes a plurality of holes at a hole density of about 90 pt/mm² or more.

According to an embodiment, the hole density may be about 90 pt/mm² to about 625 pt/mm².

According to an embodiment, the hole may have a depth of about 5 μm to about 40 μm, and according to one embodiment, the hole may have a depth of about 5 μm to about 20 μm.

According to an embodiment, the negative active material layer may include the holes at a pitch of about 100 μm or less, or about 40 μm to about 100 μm.

According to an embodiment, the negative electrode may further include an adhesive layer including a plurality of holes on the negative active material layer.

According to an embodiment, the adhesive layer may have a thickness of about 1 μm to about 5 μm.

According to an embodiment, the adhesive layer may include a vinyl-based or an acryl-based polymer, polyvinyl alcohol, a fluorine-based polymer, or a combination thereof.

According to an embodiment, the negative electrode has a loading level of about 15 mg/cm² or more.

According to one or more embodiments, a rechargeable lithium battery includes the (above) negative electrode, a positive electrode, and an electrolyte.

According to an embodiment, the negative electrode may exhibit high energy density and excellent or suitable cycle-life characteristics.

### BRIEF DESCRIPTION OF THE DRAWINGS

FIG. 1 is a drawing showing a structure of the negative electrode for a rechargeable lithium battery according to an embodiment of the present disclosure.

FIG. 2 is an exploded perspective view of a rechargeable lithium battery according to an embodiment of the present disclosure.

### DETAILED DESCRIPTION

Hereinafter, embodiments of the present disclosure are described in more detail. However, these embodiments are merely examples, the present disclosure is not limited thereto, and the present disclosure is defined by the scope of claims.

A term utilized in the specification is utilized to explain an example embodiment, but it is not intended to limited to the present disclosure. Expressions in the singular include a plurality of expressions unless the context clearly dictates otherwise.

The term “combination thereof” may include a mixture, a laminate, a complex, a copolymer, an alloy, a blend, or a reactant of constituents.

The term “comprise”, “include” or “have” is intended to designate that the performed characteristics, numbers, steps, constituted elements, or a combination thereof is present, but it should be understood that the possibility of presence or addition of one or more other characteristics, numbers, steps, constituted element, or a combination are not precluded in advance.

The drawings show that the thickness is enlarged in order to clearly show the one or more suitable layers and regions, and the same reference numerals are given to similar parts throughout the specification. When an element, such as a layer, a film, a region, a plate, and/or the like is referred to as being “on” or “over” another part, it may include cases where it is “directly on” another element, but also cases where there is another element in between. In contrast, when an element is referred to as being “directly on” another element, there are no intervening elements present.

“Layer” includes a shape totally formed on the entire surface or a shape formed on partially surface, when viewed as a plane view.

“Thickness”, for example, may be measured via an image utilizing an optical microscope, such as scanning electron microscope and/or the like.

A negative electrode for a rechargeable lithium battery according to one embodiment may include a current collector and a negative active material layer positioned on the current collector, wherein the negative active material layer may include a plurality of holes.

The negative active material layer may include the holes at a hole density of about 90 pt/mm² or more, and according to one embodiment, at a hole density of about 90 pt/mm² to about 625 pt/mm².

In the specification, “pt” indicates numbers. For example, the hole may be formed on the negative active material layer at 90 holes or more per unit area of mm², may be about 90 holes to about 625 holes, may be about 90 holes to about 400 holes, or may be about 90 holes to about 300 holes. Furthermore, about 100 holes to about 300 holes may be formed.

When the hole is formed on the negative active material layer at the hole density, charging and discharging speed may be improved without the separation of the negative active material layer from the current collector during charging and discharging, so that the rapid charge and discharge characteristics may be improved.

When the hole density is less than 90 pt/mm², increase in the charge and discharge speed may be insignificant, so it may not be suitable.

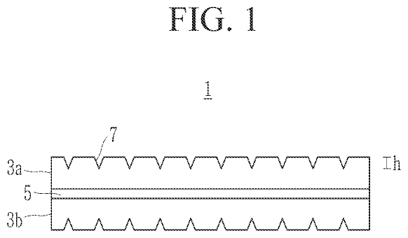

When the negative electrode 1 according to one embodiment is illustrated, referring to FIG. 1 (schematically showing the negative electrode 1), a plurality of holes (e.g., openings or pores) 7 are formed on the negative active material layers 3a and 3b, and such holes 7 are formed at about 90 holes or more per unit area of mm², and according to one embodiment, may be about 90 holes to about 625 holes, about 90 holes to about 400 holes, about, 90 holes to about 300 holes, or about 100 holes to about 300 holes.

A depth of the hole formed in the negative active material layer may be about 5 μm to about 40 μm, or about 5 μm to about 20 μm. The depth of the hole is indicated as h in FIG. 1, and in the one embodiment, the depth of the holes indicates a distance from a surface of the negative active material layer to a direction of a current collector 5.

The depth of the hole within the range may effectively suppress or reduce the deterioration of the cycle-life characteristics occurring during rapid charge and discharge.

Generally, due to the overvoltage at rapid charge and discharge, lithium may not intercalate into the active materials, and thus, it may be deposited (plated) on the surface of the active material layer. As a result, the side-reaction between the partially deposited lithium and the electrolyte may occur to inactivate lithium ions, thereby deteriorating the cycle-life characteristics.

As in the one embodiment, when the holes are formed on the negative active material layer at the depth within the range, lithium may readily intercalated into the inside of the active material layer via the holes, and thus, the charge and discharge reaction may be totally and uniformly performed in the negative active material layer, thereby more effectively improving the rapid charge and discharge characteristics.

In one embodiment, the depth of the holes is not a modified value depending on the thickness of the active material layer, so that it is desired or suitable that the holes are formed at a depth of about 5 μm to about 40 μm, even when the thickness of the active material layer is changed. In some embodiments, the minimum depth of the holes is about 5 μm, so that even though the thickness of the active material layer is reduced, the thickness of the active material layer may not be thinner than 5 μm in order to prevent or reduce penetration of the active material layer. For example, in one embodiment, the hole does not penetrate to the active material layer.

In one embodiment, the negative active material layer may include the holes at a pitch of about 100 μm or less. The pitch refers to a distance between center points of the holes located at the closest distance. Thus, the pitch does not depend on a diameter or size of the hole and is different from a length between unprocessed parts which depends on the size of the hole. According to another embodiment, the pitch may be about 40 μm to about 100 μm, about 40 μm to about 80 μm, or about 40 μm to about 75 μm.

When the pitch is within the range, the cycle-life characteristics at the rapid charge may be further improved. When the pitch is larger than 100 μm, the effects for improving the cycle-life characteristics is not sufficient, so that the practical application may be difficult.

The shape of the holes may be any shape such as a circle, an oval, or a quadrangle, and/or the like, in the flat plane, and a column, a cone, and/or the like, in a side plane, and is not limited thereto. According to one embodiment, the shape of the hole may be a circular cone shape in a side plane, a concave cone shape in which an end is hollow, or a circular cone shape in which an end is bluntly cut. According to another embodiment, the shape of the hole may be concave in which the end is hollow, and the bottom plane may be positioned on the surface of the active material layer and the hollow end may be positioned in the direction of the current collector, such as an ice cream cone.

The hole may be arranged regularly or irregularly, and it is not limited to the arrangement.

The hole may have an average diameter of about 1 μm to about 35 μm, or about 3 μm to about 35 μm. When the average diameter of the holes is within the range, the cycle-life characteristics at the rapid charge may be further improved, while the battery capacity and the strength of the active material layer may be maintained.

The average diameter may be an average diameter D50, and in the specification, when a definition is not otherwise provided, such a diameter (D50) indicates a diameter of holes, pores, or openings where a cumulative volume is about 50 volume % in a hole, pore, or opening distribution.

The average hole size (D50) may be measured by a method suitable to those skilled in the art, for example, by a hole size analyzer, or also by a transmission electron microscopic image or a scanning electron microscopic image. In some embodiments, a dynamic light-scattering measurement device is utilized to perform a data analysis, and the number of holes is counted for each hole size range. From this, the average hole diameter (D50) value may be easily obtained through a calculation.

In one embodiment, the negative electrode may further include an adhesive layer including a plurality of holes on the negative active material layer.

When the adhesive layer is further included, the volume expansion and contraction of the negative active material layer occurring during charging and discharging may be further improved.

As described above, the active material layer and the adhesive layer may include a plurality of holes so that the intercalation or deintercalation of lithium ions may effectively occur, without deterioration of energy density.

Thus, the negative electrode according to one embodiment may exhibit improvement of intercalation and deintercalation of lithium ions due to the formation of holes, substantially uniform charging and discharging, and inhibition of the shape of the electrode and improvement of the swelling characteristic due to the adhesion layer.

A thickness of the adhesive layer may be about 1 μm to about 5 μm, or according to one embodiment, about 1 μm to about 2 μm. When the thickness of the adhesive layer satisfies the range, the volume expansion and contraction of the negative active material layer due to the formation of the adhesive layer may be further inhibited.

The adhesive layer may include a vinyl-based or an acryl-based polymer, polyvinyl alcohol, a fluorine-based polymer, or a combination thereof.

The vinyl-based or acryl-based polymer, for example, may be poly(meth)acrylic acid, poly(meth)acrylate, polymethyl(meth)acrylate, polyacrylonitrile, an acrylonitrile-styrene-butadiene copolymer, or a combination thereof. The “(meth)” may indicate to include or not include a methyl group. For example, poly(meth)acrylic acid indicates polymethacrylic acid or polyacrylic acid.

The fluorine-based polymer may be a vinylidene fluoride homopolymer, for example, polyvinylidene-fluoride, a polyvinylidene fluoride-hexafluoropropylene copolymer, a polyvinylidene fluoride-trichloroethylene copolymer, a polyvinylidene fluoride-tetrafluoroethylene copolymer, a polyvinylidene fluoride-trifluoroethylene copolymer, a polyvinylidene fluoride-trifluorochloroethylene copolymer, a polyvinylidene fluoride-ethylene copolymer, or a combination thereof.

In one embodiment, the negative active material may be a material capable of reversibly intercalating/deintercalating lithium ions, lithium metal, an alloy of lithium metal, a material capable of doping and dedoping lithium, or a transition metal oxide

The material that reversibly intercalates/deintercalates lithium ions may be a carbon material that may be any generally-utilized (suitable) carbon-based negative active material utilized in a rechargeable lithium ion battery, and examples thereof may be crystalline carbon, amorphous carbon, or a combination thereof. The example of the carbon material may be crystalline carbon, amorphous carbon, or a mixture thereof. The crystalline carbon may be graphite such as unspecified shape, sheet, flake, spherical or fiber shaped natural graphite or artificial graphite, and the amorphous carbon may be soft carbon, hard carbon, mesophase pitch carbide, sintered cokes, and/or the like.

The lithium metal alloy may be an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be Si, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, and not Si), a Si-carbon composite, Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, and not Sn), a Sn-carbon composite, and/or the like. At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, and a combination thereof.

The transition elements oxide may be a lithium titanium oxide.

The Si-C composite may include silicon particles and a crystalline carbon. The silicon particle may have an average particle diameter D50 of about 10 nm to about 200 nm. The Si-C composite may further include an amorphous carbon layer formed on at least a portion. In the specification, when a definition is not otherwise provided, such a particle diameter (D50) indicates an average particle diameter (D50) where a cumulative volume is about 50 volume % in a particle distribution.

The average particle size (D50) may be measured by a method suitable to those skilled in the art, for example, by a particle size analyzer, or also by a transmission electron microscopic image or a scanning electron microscopic image. In some embodiments, a dynamic light-scattering measurement device is utilized to perform a data analysis, and the number of particles is counted for each particle size range. From this, the average particle diameter (D50) value may be easily obtained through a calculation.

In one embodiment, the negative active material may also include the silicon-based negative active material and the carbon-based negative active material. When the negative active material includes the silicon-based negative active material and the carbon-based negative active material, the mixing ratio of the silicon-based negative active material and the carbon-based negative active material may be about 1:99 to about 50:50 by weight ratio. More particularly, the mixing ratio of the silicon-based negative active material and the carbon-based negative active material may be also about 5:95 to about 20:80 by weight ratio.

In the negative active material layer, an amount of the negative active material may be about 90 wt % to about 98 wt % or about 92 wt % to about 97 wt % based on the negative active material layer.

The negative active material layer may further include a conductive material. When the negative active material layer further includes a binder, the negative active material layer includes about 90 wt % to about 98 wt % of the negative active material, about 1 wt % to about 5 wt % of the binder, and about 1 wt % to about 5 wt % of the conductive material.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamide imide, polyimide, or a combination thereof.

The aqueous binder may be a styrene-butadiene rubber, an acrylated styrene-butadiene rubber (ABR), an acrylonitrile-butadiene rubber, an acrylic rubber, a butyl rubber, a fluorine rubber, an ethylene oxide-containing polymer, polyvinyl pyrrolidone, polypropylene, polyepichlorohydrin, polyphosphazene, an ethylene propylene diene copolymer, polyvinylpyridine, chlorosulfonated polyethylene, latex, a polyester resin, an acrylic resin, a phenolic resin, an epoxy resin, polyvinyl alcohol, or a combination thereof.

When the aqueous binder is utilized as a negative electrode binder, a cellulose-based compound may be further utilized to provide viscosity as a thickener. The cellulose-based compound includes one or more of carboxymethyl cellulose, hydroxypropyl methylcellulose, methyl cellulose, or alkali metal salts thereof. The alkali metal may be Na, K, or Li. The thickener may be included in an amount of about 0.1 parts by weight to about 3 parts by weight based on 100 parts by weight of the negative active material.

The conductive material is included to provide electrode conductivity, and any electrically conductive material may be utilized as a conductive material unless it causes a chemical change. Examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal, and a combination thereof, but is not limited thereto.

The negative electrode may have an active mass density of about 1.5 g/cm³ or more, for example, may have an active mass density of about 1.5 g/cm³ to about 2.0 g/cm³.

Furthermore, the negative electrode may have a loading level of about 15 mg/cm² or more, or about 18 mg/cm² or more. The loading level of about 15 mg/cm² or more of the negative electrode renders greater improvement in the formation of holes at the hole density according to one embodiment. That, the effect by forming holes may be more effectively obtained from the negative electrode with such high loading level. The loading level of the negative electrode of about 15 mg/cm² or more is appropriate or suitable, so that it is not necessary to limit the upper limit, but the loading level may be, for example about 18 mg/cm² to about 36 mg/cm².

A thickness of the negative active material layer may be about 100 μm or more, and about 200 μm or less. The thickness of the negative active material layer indicates a thickness of the one side. When the thickness of the negative active material layer is within the range, suitable battery capacity may be exhibited.

The negative electrode according to one embodiment may be produced by preparing a negative active material layer on the current collector and forming holes. In some embodiments, the negative electrode may also be produced by preparing an adhesive layer on the negative active material layer and then forming holes.

The hole formation process may be any techniques, as long as the holes may be formed, and for example, needle punching, a laser, and/or the like.

The negative active material layer preparation may be performed by a general technique including coating a negative active material layer composition including a negative active material, a binder, optionally, a conductive material, and a solvent on a current collector, and drying and pressurizing. The solvent may be N-methyl pyrrolidone, water, or a combination thereof, and when binder is utilized as the aqueous binder, water may be utilized as the solvent.

The adhesive layer preparation may be a general technique including coating an adhesive layer composition including a vinyl-based or an acryl-based polymer, polyvinyl alcohol, a fluorine-based polymer, or a combination thereof, and a solvent, on the negative active material layer, and drying and pressurizing.

The solvent may be water.

Another embodiment provides a rechargeable lithium battery including the negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions. For example, one or more composite oxides of a metal selected from cobalt, manganese, nickel, and a combination thereof, and lithium may be utilized. More specifically, the compounds represented by one of the following chemical formulae may be utilized. LiₐA_{1-b}X_{b}D₂ (0.90≤a≤1.8, 0≤b≤0.5); LiₐA_{1-b}X_{b}O_{2-c}D_{c}(0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5≤c≤0.05); LiₐNi_{1-b-c}Co_{b}X_{c}D_{α} (0.90≤a≤1.8, 0≤b≤0.5, 0≤c≤0.5, 0<α≤2); LiₐNi_{1-b-c}Co_{b}X_{c}O_{2-α}T_{α} (0.90≤a≤1.8, 0≤b≤0.5, 0≤c≤0.5, 0α<2); LiₐNi_{1-b-c}Co_{b}X_{c}O_{2-α}T₂(0.90≤a≤1.8, 0b≤0.5, 0≤c≤0.5, 0<α<2); LiₐNi_{1-b-c}Mn_{b}X_{c}D_{α} (0.90≤a≤1.8, 0≤b≤0.5, 0≤c≤0.5, 0<α<2); LiₐNi_{1-b-c}Mn_{b}X_{c}O_{2-α}T_{α} (0.90≤a≤1.8, 0≤b≤0.5, 0≤c≤0.06, 0<α<2); LiₐNi_{1-b-c}Mn_{b}X_{c}O_{2-α}T_{α} (0.90≤a≤1.8,0≤b≤0.5, 0≤c≤0.5, 0<α<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GₑO₂(0.90≤a≤1.8, 0≤b≤0.9, 0≤c≤0.5, 0≤d≤0.5, 0≤e≤0.1); LiₐNi_{b}Co_{c}Al_{d}GₑO₂ (0.90≤a≤1.8, 0≤a≤1.8, 0≤b≤0.9, 0≤c≤0.5, 0≤d≤0.5, 0≤d≤0.5, 0≤e≤0.1); LiₐNi_{b}Co_{c}Mn_{d}GₑO₂ (0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQs₂; V₂O₅; LiV₂O₅; LiZO₂; LiNiVO₄; Li_{(3-f)}J₂ PO₄₃ (0≤f≤2); Li (3-f)Fe₂ PO₄₃ (0≤f≤2); LiaFePO₄ (0.90≤a≤1.8)

In the above chemical formulae, A is selected from Ni, Co, Mn, and a combination thereof; X is selected from Al, Ni, Co, Mn, Cr, Fe, Mg, Sr, V, a rare earth element, and a combination thereof; D¹ is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating layer may be disposed in a method having no adverse influence on properties of a positive electrode active material by utilizing these elements in the compound, and for example, the method may include any coating method such as spray coating, dipping, and/or the like, but is not illustrated in more detail because it is suitable in the related field.

In the positive electrode, an amount of the positive active material may be about 90 wt % to about 98 wt % based on the total weight of the positive active material layer.

In an embodiment of the present disclosure, the positive active material layer may further include a binder and a conductive material. Herein, the binder and the conductive material may be included in an amount of about 1 wt % to about 5 wt %, respectively based on the total amount of the positive active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and/or the like, but are not limited thereto.

The conductive material is included to provide electrode conductivity, and any electrically conductive material may be utilized as a conductive material unless it causes a chemical change. Examples of the conductive material include a carbon-based material such as natural graphite, artificial graphite, carbon black, acetylene black, ketjen black, a carbon fiber, and/or the like; a metal-based material of a metal powder or a metal fiber including copper, nickel, aluminum, silver, and/or the like; a conductive polymer such as a polyphenylene derivative; or a mixture thereof.

The current collector may utilize aluminum foil, nickel foil, or a combination thereof, but is not limited thereto.

The electrolyte includes a non-aqueous organic solvent and a lithium salt.

The non-aqueous organic solvent serves as a medium for transmitting ions taking part in the electrochemical reaction of a battery.

The non-aqueous organic solvent may include a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent may include cyclohexanone and/or the like. The alcohol-based solvent may include ethyl alcohol, isopropyl alcohol, and/or the like, and examples of the aprotic solvent include nitriles such as R-CN (where R is a C2 to C20 linear, branched, or cyclic hydrocarbon, and may include a double bond, an aromatic ring, or an ether bond), amides such as dimethylformamide, dioxolanes such as 1,3-dioxolane, sulfolanes, and/or the like.

The organic solvent may be utilized alone or in a mixture. When the organic solvent is utilized in a mixture, the mixture ratio may be controlled or selected in accordance with a desirable battery performance and it may be well suitable to one in the related art.

Furthermore, the carbonate-based solvent may desirably include a mixture with a cyclic carbonate and a linear carbonate. The cyclic carbonate and linear carbonate are mixed together in a volume ratio of about 1:1 to about 1:9, and when the mixture is utilized as an electrolyte, it may have enhanced performance.

The organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

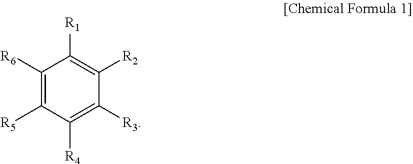

In Chemical Formula 1, R₁ to R₆ may each independently be the same or different and are selected from hydrogen, a halogen, a Cl to C10 alkyl group, a haloalkyl group, and a combination thereof.

Specific examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylethyl carbonate, vinylene carbonate, or an ethylene carbonate-based compound represented by Chemical Formula 2, as an additive for improving cycle life.

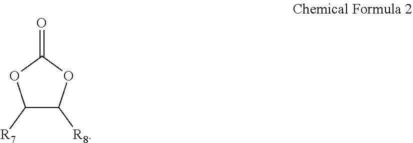

In Chemical Formula 2, R₇ and R₈ may each independently be the same or different and may each independently be hydrogen, a halogen, a cyano group (CN), a nitro group (NO₂), or a C1 to C5 fluoroalkyl group, provided that at least one of R₇ and R₈ is a halogen, a cyano group (CN), a nitro group (NO₂), or a C1 to C5 fluoroalkyl group, and R₇ and R₈ are not both (e.g., simultaneously) hydrogen.

Examples of the ethylene carbonate-based compound may be difluoro ethylenecarbonate, chloroethylene carbonate, dichloroethylene carbonate, bromoethylene carbonate, dibromoethylene carbonate, nitroethylene carbonate, cyanoethylene carbonate, fluoroethylene carbonate, and/or the like. An amount of the additive for improving the cycle-life characteristics may be utilized within an appropriate or suitable range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide: LiFSI), LiC₄F₉SO₃, LiClO₄, LiAlO₂, LiAICl₄, LiPO₂F₂, LiN(CₓF₂ₓ₊₁SO₂)(C_{y}F_{2y+1}SO₂), wherein x and y are natural numbers, for example, an integer of about 1 to about 20), lithium difluoro(bisoxolato) phosphate), LiCI, Lil, LiB(C₂O₄)₂(lithium bis(oxalato) borate: LiBOB) and lithium difluoro(oxalato)borate (LiDFOB). A concentration of the lithium salt may range from about 0.1 M to about 2.0 M. When the lithium salt is included at the above concentration range, an electrolyte may have excellent or suitable performance and lithium ion mobility due to optimal or suitable electrolyte conductivity and viscosity.

A separator may be disposed between the positive electrode and the negative electrode depending on a type or kind of a rechargeable lithium battery. The separator may utilize polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

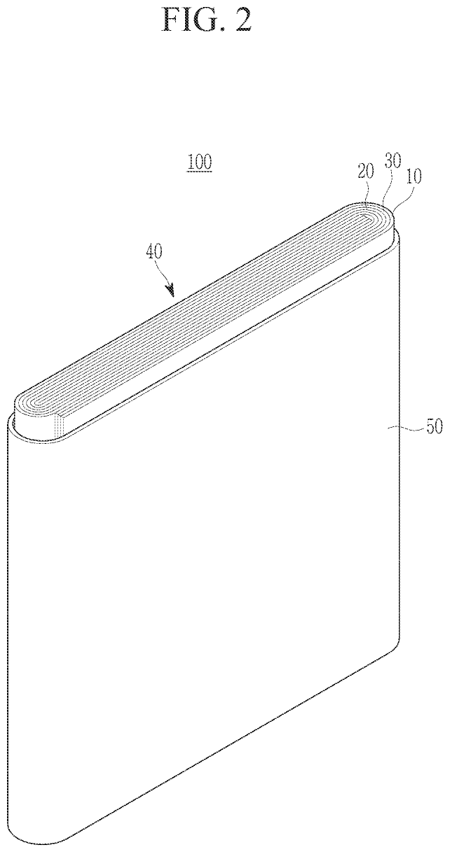

FIG. 2 is an exploded perspective view of a rechargeable lithium battery according to an embodiment. The rechargeable lithium battery according to an embodiment is illustrated as a prismatic battery but is not limited thereto and may include variously-shaped batteries such as a cylindrical battery, a pouch battery, and/or the like.

Referring to FIG. 2, a rechargeable lithium battery 100 according to an embodiment may include an electrode assembly 40 manufactured by winding a separator 30 disposed between a positive electrode 10 and a negative electrode 20 and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### Cell Configuration Modification Test

### EXAMPLE 1

96 wt % of an artificial graphite negative active material, 1 wt % of a styrene-butadiene rubber binder, 1 wt % of a carboxymethyl cellulose thickener, and 2 wt % of a carbon black conductive material were mixed in a water solvent to prepare a negative active material layer slurry.

The negative active material layer slurry was coated on a copper foil current collector and dried followed by pressing to prepare a negative active material layer on the current collector.

The obtained product was subjected to needle punching to form holes with a hole depth of 20 μm and a hole diameter of 20 μm at a hole density of 100 pt/mm²and a hole pitch of 100 μm, thereby preparing a negative electrode including a negative active material layer having holes. An active mass density of the negative electrode was 1.45 g/cm³, the one side thickness of the negative active material layer was 124 μm, and the one side loading level (L/L) was 18.0 mg/cm².

95 wt % of a LiCoO₂ positive active material, 3 wt % of a polyvinylidene fluoride binder, and 2 wt % of a ketjen black conductive material were mixed in an N-methyl pyrrolidone solvent to prepare a positive active material slurry. The positive active material slurry was coated on an aluminum current collector and dried followed by pressing to prepare a positive electrode.

Using (utilizing) the negative electrode, a polyethylene/polypropylene separator, the positive electrode, and an electrolyte, a rechargeable lithium cell with a current density of 3 mA/cm² was fabricated by the general procedure. The electrolyte was prepared by utilizing a mixed solvent of ethylene carbonate and diethyl carbonate (50:50 volume ratio) and dissolving 1 M LiPF₆ therein.

### EXAMPLE 2

A negative electrode was prepared by the same procedure as in Example 1, except that active mass density was changed to 1.5 g/cm³, and the one side thickness of the negative active material layer was changed to 120 μm. Using the negative electrode, a rechargeable lithium cell was fabricated by the same procedure as in Example 1.

### EXAMPLE 3

A negative electrode was prepared by the same procedure as in Example 1, except that active mass density was changed to 1.53 g/cm³, and the one side thickness of the negative active material layer was changed to 118 μm. Using the negative electrode, a rechargeable lithium cell was fabricated by the same procedure as in Example 1.

### EXAMPLE 4

A negative electrode was prepared by the same procedure as in Example 1, except that active mass density was changed to 1.58 g/cm³, and the one side-thickness of the negative active material layer was changed to 114 μm. Using the negative electrode, a rechargeable lithium cell was fabricated by the same procedure as in Example 1.

### EXAMPLE 5

A negative electrode was prepared by the same procedure as in Example 1, except that active mass density was changed to 1.53 g/cm³, the one side thickness of the negative active material layer was changed to 106 μm, and the one side loading level (L/L) was changed to 16.2 mg/cm². Using the negative electrode, the electrolyte and the separator of Example 1, a rechargeable lithium cell with a current density of 2.7 mA/cm² was fabricated by the general method.

### EXAMPLE 6

A negative electrode was prepared by the same procedure as in Example 1, except that active mass density was changed to 1.53 g/cm³, the one side thickness of the negative active material layer was changed to 137 μm, and the one side loading level (L/L) was changed to 21.0 mg/cm². Using the negative electrode, the electrolyte and the separator of Example 1, a rechargeable lithium cell with a current density of 3.5 mA/cm² was fabricated by the general method.

### COMPARATIVE EXAMPLE 1

A negative electrode was prepared by the same procedure as in Example 1, except that the needle punching was not performed, active mass density was changed to 1.45 g/cm³, the one side thickness of the negative active material layer was changed to 124 μm, and the one side loading level (L/L) was changed to 18.0 mg/cm². Using the negative electrode, a rechargeable lithium cell was fabricated by the same procedure as in Example 1.

### COMPARATIVE EXAMPLE 2

A negative electrode was prepared by the same procedure as in Example 2, except that the needle punching was not performed, active mass density was changed to 1.5 g/cm³, the one side thickness of the negative active material layer was changed to 120 μm, and the one side loading level (L/L) was changed to 18.0 mg/cm². Using the negative electrode, a rechargeable lithium cell was fabricated by the same procedure as in Example 2.

### COMPARATIVE EXAMPLE 3

A negative electrode was prepared by the same procedure as in Example 3, except that the needle punching was not performed, active mass density was changed to 1.53 g/cm³, the one side thickness of the negative active material layer was changed to 118 μm, and the one side loading level (L/L) was changed to 18.0 mg/cm². Using the negative electrode, a rechargeable lithium cell was fabricated by the same procedure as in Example 3.

### COMPARATIVE EXAMPLE 4

A negative electrode was prepared by the same procedure as in Example 4, except that the needle punching was not performed, active mass density was changed to 1.58 g/cm³, the one side thickness of the negative active material layer was changed to 114 μm, and the one side loading level (L/L) was changed to 18.0 mg/cm². Using the negative electrode, a rechargeable lithium cell was fabricated by the same procedure as in Example 4.

### COMPARATIVE EXAMPLE 5

A negative electrode was prepared by the same procedure as in Example 5, except that the needle punching was not performed, active mass density was changed to 1.53 g/cm³, the one side thickness of the negative active material layer was changed to 106 μm, and the one side loading level (L/L) was changed to 16.2 mg/cm². Using the negative electrode, the electrolyte, and the separator of Example 1, a rechargeable lithium cell with a current density of 2.7 mA/cm² was fabricated by the general method.

### COMPARATIVE EXAMPLE 6

A negative electrode was prepared by the same procedure as in Example 6, except that the needle punching was not performed, active mass density was changed to 1.53 g/cm³, the one side thickness of the negative active material layer was changed to 137 μm, and the one side loading level (L/L) was changed to 21.0 mg/cm². Using the negative electrode, the electrolyte, and the separator of Example 1, a rechargeable lithium cell with a current density of 3.5 mA/cm² was fabricated by the general method.

### EXAMPLE 7

25 wt % of polyacrylic acid and 75 wt % of polyvinylidene fluoride were mixed in a water solvent to prepare an adhesive layer slurry.

The negative active material layer slurry of Example 1 was coated on a copper foil current collector and dried followed by pressing to prepare a negative active material layer on the current collector. Thereafter, the adhesive layer slurry was coated on the negative active material layer and dried followed by pressing to prepare an adhesive layer.

The product in which the negative active material layer and the adhesive layer were prepared was subjected to needle punching to form holes with a hole depth of 20 μm and a hole diameter of 20 μm at a hole density of 100 pt/mm²and a hole pitch of 100 μm, thereby preparing a negative electrode including a negative active material layer having holes. An active mass density of the negative electrode was 1.45 g/cm³, the one side thickness of the negative active material layer was 124 μm, and the one side loading level (L/L) was 18.0 mg/cm².

95 wt % of a LiCoO2 positive active material, 3 wt % of a polyvinylidene fluoride binder, and 2 wt % of a ketjen black conductive material were mixed in an N-methyl pyrrolidone solvent to prepare a positive active material slurry. The positive active material slurry was coated on an aluminum current collector and dried followed by pressing to prepare a positive electrode.

Using the negative electrode, a polyethylene/polypropylene separator, the positive electrode, and an electrolyte, a rechargeable lithium cell with a current density of 3 mA/cm² was fabricated by the general procedure. The electrolyte was prepared by utilizing a mixed solvent of ethylene carbonate and diethyl carbonate (50:50 volume ratio) and dissolving 1 M LiPF₆ therein.

### EXAMPLE 8

A negative electrode was prepared by the same procedure as in Example 7, except that active mass density was changed to 1.5 g/cm³, and the one side thickness of the negative active material layer was changed to 120 μm. Using the negative electrode, a rechargeable lithium cell was fabricated by the same procedure as in Example 7.

### EXAMPLE 9

A negative electrode was prepared by the same procedure as in Example 7, except that active mass density was changed to 1.53 g/cm³, and the one side thickness of the negative active material layer was changed to 118 μm. Using the negative electrode, a rechargeable lithium cell was fabricated by the same procedure as in Example 7.

### EXAMPLE 10

A negative electrode was prepared by the same procedure as in Example 7, except that active mass density was changed to 1.58 g/cm³, and the one side thickness of the negative active material layer was changed to 114 μm. Using the negative electrode, a rechargeable lithium cell was fabricated by the same procedure as in Example 7.

### EXAMPLE 11

A negative electrode was prepared by the same procedure as in Example 7, except that active mass density was changed to 1.53 g/cm³, the one side thickness of the negative active material layer was changed to 106 μm, and the one side loading level (L/L) was changed to 16.2 mg/cm². Using the negative electrode, the electrolyte, and the separator of Example 7, a rechargeable lithium cell with a current density of 2.7 mA/cm² was fabricated by the general method.

### EXAMPLE 12

A negative electrode was prepared by the same procedure as in Example 1, except that active mass density was changed to 1.53 g/cm³, the one side thickness of the negative active material layer was changed to 137 μm, and the one side loading level (L/L) was changed to 21.0 mg/cm². Using the negative electrode, the electrolyte, and the separator of Example 7, a rechargeable lithium cell with a current density of 3.5 mA/cm² was fabricated by the general method.

### COMPARATIVE EXAMPLE 7

A negative electrode was prepared by the same procedure as in Example 7, except that the needle punching was not performed, active mass density was changed to 1.45 g/cm³, the one side thickness of the negative active material layer was changed to 124 μm, and the one side loading level (L/L) was changed to 18.0 mg/cm². Using the negative electrode, a rechargeable lithium cell was fabricated by the same procedure as in Example 7.

### COMPARATIVE EXAMPLE 8

A negative electrode was prepared by the same procedure as in Example 8, except that the needle punching was not performed, active mass density was changed to 1.5 g/cm³, the one side thickness of the negative active material layer was changed to 120 μm, and the one side loading level (L/L) was changed to 18.0 mg/cm². Using the negative electrode, a rechargeable lithium cell was fabricated by the same procedure as in Example 8.

### COMPARATIVE EXAMPLE 9

A negative electrode was prepared by the same procedure as in Example 9, except that the needle punching was not performed, active mass density was changed to 1.53 g/cm³, the one side thickness of the negative active material layer was changed to 118 μm, and the one side loading level (L/L) was changed to 18.0 mg/cm². Using the negative electrode, a rechargeable lithium cell was fabricated by the same procedure as in Example 9.

### COMPARATIVE EXAMPLE 10

A negative electrode was prepared by the same procedure as in Example 10, except that the needle punching was not performed, active mass density was changed to 1.58 g/cm³, the one side thickness of the negative active material layer was changed to 114 μm, and the one side loading level (L/L) was changed to 18.0 mg/cm². Using the negative electrode, a rechargeable lithium cell was fabricated by the same procedure as in Example 10.

### COMPARATIVE EXAMPLE 11

A negative electrode was prepared by the same procedure as in Example 11, except that the needle punching was not performed, active mass density was changed to 1.53 g/cm³, the one side thickness of the negative active material layer was changed to 106 μm, and the one side loading level (L/L) was changed to 16.2 mg/cm². Using the negative electrode, the electrolyte, and the separator of Example 7, a rechargeable lithium cell with a current density of 2.7 mA/cm² was fabricated by the general method.

### COMPARATIVE EXAMPLE 12

A negative electrode was prepared by the same procedure as in Example 12, except that the needle punching was not performed, active mass density was changed to 1.53 g/cm³, the one side thickness of the negative active material layer was changed to 137 μm, and the one side loading level (L/L) was changed to 21.0 mg/cm². Using the negative electrode, the electrolyte and the separator of Example 1, a rechargeable lithium cell with a current density of 3.5 mA/cm² was fabricated by the general method.

The battery cell configurations of Examples 1 to 12 and Comparative Examples 1 to 12 are summarized in Table 1.

### EXPERIMENTAL EXAMPLE 1

### Evaluation of Adherence

In the negative electrodes according to Examples 1 to 12 and Comparative Examples 1 to 12, it was measured whether the active material layer was detached or not.

The negative electrode was cut into a circle with a diameter of 36 mm, and powder detached therefrom during the process was removed by air blowing and a weight of the cut negative electrode was measured to obtain an initial weight of the negative electrode.

The cut negative electrode was folded in half in the longitudinal direction, the folded portion was pressed once with a metal roll by 500 g, and then flattened. Thereafter, it was folded in half in the horizontal direction and the folded part was pressed once with a metal roll at 500 g. Thereafter, the negative electrode was flattened and the detached powder was removed, and a weight of the flattened negative electrode was measured to obtain a final weight of the negative electrode weight.

The detached amount was calculated by the following Equation 1 and the no detachment of the active material layer (the detached amount is 10% or less) was to be OK and the detachment of the active material layer (the detached amount is more than 10%) was to be NG. The results are shown in Table 2.

Detached amount (%)=[(initial weight of negative electrode-final amount of negative electrode weight)/initial weight of negative electrode]*100 Equation 1

### EXPERIMENTAL EXAMPLE 2

### Evaluation of Capacity

The rechargeable lithium cells according to Examples 1 to 12 and Comparative Examples 1 to 12 were charged and discharged once at 0.1 C, and the discharge capacity was measured. The results are shown in Table 2, as cell capacity.

### EXPERIMENTAL EXAMPLE 3

### Evaluation of Capacity Retention

The rechargeable lithium cells according to Examples 1 to 12 and Comparative Examples 1 to 12 were charged and discharged at 3 C for 200 cycles. The ratio of the discharge capacity at the 200th cycle to the discharge capacity at the 1St was obtained. The results are shown in Table 2.

### EXPERIMENTAL EXAMPLE 4

### Evaluation of Swelling Characteristic

The rechargeable lithium cells according to Examples 1 to 12 and Comparative Examples 1 to 12 were charged and discharged at 3 C for 200 cycles. Thickness of the cell before charge and discharge and thickness of the cell after charge and discharge were measured, respectively. The increase ratio % of the thickness after 200 cycles to thickness before charging and discharging which was to be 100%, was measured. The results are shown in Table 2, as swelling.

### EXPERIMENTAL EXAMPLE 5

### Evaluation of Resistance Characteristic

The rechargeable lithium cells according to Examples 1 to 12 and Comparative Examples 1 to 12 were charged and discharged at 3 C for 200 cycles, and resistance was measured. The results are shown in Table 2.

TABLE 1

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer or | density | level | density | thickness |
| | not | (pt/mm²) | (μm) | (μm) | (μm) | not | (mA/cm²) | (mg/cm²) | (g/cm³) | (μm) |
| Comparative | No | — | — | — | — | No | 3 | 18.0 | 1.45 | 124 |
| Example 1 | | | | | | | | | | |
| Comparative | No | — | — | — | — | No | 3 | 18.0 | 1.5 | 120 |
| Example 2 | | | | | | | | | | |
| Comparative | No | — | — | — | — | No | 3 | 18.0 | 1.53 | 118 |
| Example 3 | | | | | | | | | | |
| Comparative | No | — | — | — | — | No | 3 | 18.0 | 1.58 | 114 |
| Example 4 | | | | | | | | | | |
| Comparative | No | — | — | — | — | No | 2.7 | 16.2 | 1.53 | 106 |
| Example 5 | | | | | | | | | | |
| Comparative | No | — | — | — | — | No | 3.5 | 21.0 | 1.53 | 137 |
| Example 6 | | | | | | | | | | |
| Example 1 | Yes | 100 | 100 | 20 | 20 | No | 3 | 18.0 | 1.45 | 124 |
| Example 2 | Yes | 100 | 100 | 20 | 20 | No | 3 | 18.0 | 1.5 | 120 |
| Example 3 | Yes | 100 | 100 | 20 | 20 | No | 3 | 18.0 | 1.53 | 118 |
| Example 4 | Yes | 100 | 100 | 20 | 20 | No | 3 | 18.0 | 1.58 | 114 |
| Example 5 | Yes | 100 | 100 | 20 | 20 | No | 2.7 | 16.2 | 1.53 | 106 |
| Example 6 | Yes | 100 | 20 | 20 | 20 | No | 3.5 | 21.0 | 1.53 | 137 |
| Comparative | No | — | — | — | — | Yes | 3 | 18.0 | 1.45 | 124 |
| Example 7 | | | | | | | | | | |
| Comparative | No | | | | | Yes | 3 | 18.0 | 1.5 | 120 |
| Example 8 | | | | | | | | | | |
| Comparative | No | | | | | Yes | 3 | 18.0 | 1.53 | 118 |
| Example 9 | | | | | | | | | | |
| Comparative | No | — | — | — | — | Yes | 3 | 18.0 | 1.58 | 114 |
| Example 10 | | | | | | | | | | |
| Comparative | No | — | — | — | — | Yes | 2.7 | 16.2 | 1.53 | 106 |
| Example 11 | | | | | | | | | | |
| Comparative | No | — | — | — | — | Yes | 3.5 | 21.0 | 1.53 | 137 |
| Example 12 | | | | | | | | | | |
| Example 7 | Yes | 100 | 100 | 20 | 20 | Yes | 3 | 18.0 | 1.45 | 124 |
| Example 8 | Yes | 100 | 100 | 20 | 20 | Yes | 3 | 18.0 | 1.5 | 120 |
| Example 9 | Yes | 100 | 100 | 20 | 20 | Yes | 3 | 18.0 | 1.53 | 118 |
| Example 10 | Yes | 100 | 100 | 20 | 20 | Yes | 3 | 18.0 | 1.58 | 114 |
| Example 11 | Yes | 100 | 100 | 20 | 20 | Yes | 2.7 | 16.2 | 1.53 | 106 |
| Example 12 | Yes | 100 | 20 | 20 | 20 | Yes | 3.5 | 21.0 | 1.53 | 137 |

TABLE 2

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.44 | 99.6 | 95.0 | 5.90 | 9.9 |
| Example 1 | | | | | | |
| Comparative | OK | 0.41 | 99.8 | 94.5 | 6.00 | 10.0 |
| Example 2 | | | | | | |
| Comparative | OK | 0.43 | 99.4 | 93.0 | 6.30 | 10.1 |
| Example 3 | | | | | | |
| Comparative | OK | 0.40 | 100.3 | 88.0 | 7.30 | 10.5 |
| Example 4 | | | | | | |
| Comparative | OK | 0.41 | 99.5 | 95.3 | 5.84 | 9.9 |
| Example 5 | | | | | | |
| Comparative | OK | 0.42 | 100.9 | 89.5 | 7.00 | 10.4 |
| Example 6 | | | | | | |
| Example 1 | OK | 0.43 | 99.5 | 95.2 | 4.10 | 9.9 |
| Example 2 | OK | 0.43 | 99.2 | 94.8 | 4.18 | 10.0 |
| Example 3 | OK | 0.43 | 100.7 | 94.2 | 4.30 | 9.1 |
| Example 4 | OK | 0.48 | 99.2 | 92.0 | 4.74 | 10.2 |
| Example 5 | OK | 0.44 | 99.8 | 96.0 | 3.94 | 9.9 |
| Example 6 | OK | 0.45 | 100.1 | 92.0 | 4.74 | 10.2 |
| Comparative | OK | 0.46 | 100.5 | 94.8 | 3.70 | 13.0 |
| Example 7 | | | | | | |
| Comparative | OK | 0.42 | 100.2 | 94.2 | 8.82 | 13.0 |
| Example 8 | | | | | | |
| Comparative | OK | 0.48 | 100.6 | 91.8 | 4.30 | 12.1 |
| Example 9 | | | | | | |
| Comparative | OK | 0.50 | 99.8 | 86.0 | 5.46 | 13.7 |
| Example 10 | | | | | | |
| Comparative | OK | 0.40 | 99.30 | 94.8 | 3.70 | 13.0 |
| Example 11 | | | | | | |
| Comparative | OK | 0.45 | 100.7 | 88.0 | 5.06 | 13.5 |
| Example 12 | | | | | | |
| Example 7 | OK | 0.41 | 99.3 | 94.8 | 2.84 | 10.0 |
| Example 8 | OK | 0.48 | 101.00 | 94.6 | 2.86 | 10.0 |
| Example 9 | OK | 0.47 | 99.5 | 94.0 | 2.90 | 9.9 |
| Example 10 | OK | 0.47 | 100.2 | 91.4 | 3.08 | 10.2 |
| Example 11 | OK | 0.43 | 100.5 | 95.9 | 2.77 | 9.9 |
| Example 12 | OK | 0.47 | 99.2 | 91.9 | 3.05 | 10.2 |

As shown in Table 2, Examples 1 to 12 in which a plurality of holes were formed on the active material layer at a hole density of 100 pt/mm² or more exhibited improved capacity retention at the same loading level, compared to Comparative

Examples 1 to 12. From these results, even though the adhesive layer is prepared, along with the hole (Example 7 to 12), the capacity retention was improved at the same active mass density.

Furthermore, Examples 1 to 12 exhibited good or suitable swelling characteristics (i.e., low swelling) compared to Comparative Examples 1 to 12, and lower resistance than Comparative Examples 1 to 12.

Test for modification of hole density-utilizing needle punching

### COMPARATIVE EXAMPLES 13 to 16, EXAMPLES 13 to 20, AND REFERENCE EXAMPLES 1 to 3

A negative electrode having a negative active material layer and an adhesive layer was prepared by the same procedure as in Example 9, except that the obtained product was subjected to needle punching to change hole density, hole pitch, hole depth and hole diameter to as shown in Table 3.

Using the negative electrode, the electrolyte, and the separator of Example 9, a rechargeable lithium cell with a current density shown in Table 3 was fabricated by the general method.

The cell characteristics of Examples 13 to 20, Comparative Examples 13 to 16, and Reference Examples 1 to 3 were measured by the same methods as in Experimental Examples 1 to 5. The results are shown in Table 4. For comparison, the results of Comparative Examples 9 and 12, and Example 9 are also shown in Table 4.

TABLE 3

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer or | density | level | density | thickness |
| | not | (pt/mm²) | (μm) | (μm) | (μm) | not | (mA/cm²) | (mg/cm²) | (g/cm³) | (μm) |
| Comparative | No | — | — | — | — | Yes | 3 | 18.0 | 1.53 | 118 |
| Example 9 | | | | | | | | | | |
| Comparative | Yes | 50 | 142 | 20 | 20 | Yes | 3 | 18.0 | 1.53 | 118 |
| Example 13 | | | | | | | | | | |
| Example 9 | Yes | 100 | 100 | 20 | 20 | Yes | 3 | 18.0 | 1.53 | 118 |
| Example 13 | Yes | 200 | 71 | 20 | 20 | Yes | 3 | 18.0 | 1.53 | 118 |
| Example 14 | Yes | 625 | 40 | 10 | 10 | Yes | 3 | 18.0 | 1.53 | 118 |
| Reference | Yes | 800 | 35.4 | 10 | 10 | Yes | 3 | 18.0 | 1.53 | 118 |
| Example 1 | | | | | | | | | | |
| Comparative | No | — | — | 20 | — | Yes | 3.5 | 21.0 | 1.53 | 137 |
| Example 12 | | | | | | | | | | |
| Comparative | Yes | 50 | 142 | 20 | 20 | Yes | 3.5 | 21.0 | 1.53 | 137 |
| Example 14 | | | | | | | | | | |
| Example 15 | Yes | 100 | 100 | 20 | 20 | Yes | 3.5 | 21.0 | 1.53 | 137 |
| Example 16 | Yes | 200 | 71 | 20 | 20 | Yes | 3.5 | 21.0 | 1.53 | 137 |
| Example 17 | Yes | 625 | 40 | 10 | 10 | Yes | 3.5 | 21.0 | 1.53 | 137 |
| Reference | Yes | 800 | 35.4 | 10 | 10 | Yes | 3.5 | 21.0 | 1.53 | 137 |
| Example 2 | | | | | | | | | | |
| Comparative | No | — | — | — | — | Yes | 6.1 | 34.0 | 1.53 | 222 |
| Example 15 | | | | | | | | | | |
| Comparative | Yes | 50 | 142 | 20 | 20 | Yes | 6.1 | 34.0 | 1.53 | 222 |
| Example 16 | | | | | | | | | | |
| Example 18 | Yes | 100 | 100 | 20 | 20 | Yes | 6.1 | 34.0 | 1.53 | 222 |
| Example 19 | Yes | 200 | 71 | 20 | 20 | Yes | 6.1 | 34.0 | 1.53 | 222 |
| Example 20 | Yes | 625 | 40 | 10 | 10 | Yes | 6.1 | 34.0 | 1.53 | 222 |
| Reference | Yes | 800 | 35.4 | 10 | 10 | Yes | 6.1 | 34.0 | 1.53 | 222 |
| Example 3 | | | | | | | | | | |

TABLE 4

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.48 | 99.6 | 91.8 | 4.30 | 12.1 |
| Example 9 | | | | | | |
| Comparative | OK | 0.48 | 99.30 | 92.3 | 3.02 | 10.2 |
| Example 13 | | | | | | |
| Example 9 | OK | 0.46 | 100.8 | 94.0 | 2.90 | 9.9 |
| Example 13 | OK | 0.48 | 100.1 | 95.2 | 2.82 | 10.2 |
| Example 14 | OK | 0.45 | 100.0 | 95.8 | 2.81 | 10.1 |
| Reference | NG | 1.23 | 98.6 | — | — | — |
| Example 1 | | | | | | |
| Comparative | OK | 0.45 | 100.7 | 88.0 | 5.06 | 13.5 |
| Example 12 | | | | | | |
| Comparative | OK | 0.41 | 100.50 | 88.8 | 3.42 | 13.0 |
| Example 14 | | | | | | |
| Example 15 | OK | 0.43 | 100.1 | 91.9 | 3.20 | 13.1 |
| Example 16 | OK | 0.40 | 99.4 | 93.2 | 3.11 | 15.1 |
| Example 17 | OK | 0.42 | 99.6 | 93.4 | 3.10 | 14.8 |
| Reference | NG | 1.12 | 98.90 | — | — | — |
| Example 2 | | | | | | |
| Comparative | OK | 0.43 | 100.8 | 80.0 | 5.92 | 12.9 |
| Example 15 | | | | | | |
| Comparative | OK | 0.47 | 99.3 | 81.7 | 5.79 | 13.5 |
| Example 16 | | | | | | |
| Example 18 | OK | 0.41 | 100.3 | 87.8 | 5.30 | 10.0 |
| Example 19 | OK | 0.41 | 99.3 | 89.6 | 5.16 | 10.1 |
| Example 20 | OK | 0.43 | 99.5 | 90.1 | 5.10 | 10.2 |
| Reference | NG | 1.24 | 98.60 | — | — | — |
| Example 3 | | | | | | |

As shown in Table 4, Examples 9 and 13 to 20 in which holes were formed at a suitable hole density exhibited excellent or suitable capacity retention, an excellent or suitable swelling characteristic and low resistance at the same loading level. Whereas, when the holes were not formed (Comparative Examples 9, and 12 and 15), or even when holes were formed, Comparative Examples 13, 14 and 16, having too low hole density, exhibited low capacity retention, deteriorated swelling characteristics, and high resistance at the same loading level. In some embodiments, Reference Examples 1 to 3 having too high hole density of 800 pt/mm², exhibited too weak adherence, causing detachment.

Test for Modification of Hole Density-Utilizing Laser Processing

### COMPARATIVE EXAMPLE 17 TO 19, EXAMPLES 21 TO 29

A negative electrode having a negative active material layer and an adhesive layer was prepared by the same procedure as in Example 9, except that the obtained product was subjected to laser processing utilizing a WS-FLEX IR Femtosecond laser work station to change hole density, hole pitch, hole depth and hole diameter to as shown in Table 5.

Using the negative electrode, the electrolyte, and the separator of Example 9, a rechargeable lithium cell with a current density shown in Table 5 was fabricated by the general method.

The cell characteristics of Examples 21 to 29 and Comparative Examples 17 to 19 were measured by the same methods as in Experimental Examples 1 to 5. The results are shown in Table 6. For comparison, the results of Comparative Examples 9, 12, and 15 are also shown in Table 6.

TABLE 5

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer | density | level | density | thickness |
| | not | (pt/mm²) | (μm) | (μm) | (μm) | or not | (mA/cm²) | (mg/cm²) | (g/cm³) | (μm) |
| Comparative | No | — | — | — | — | Yes | 3 | 18.0 | 1.53 | 118 |
| Example 9 | | | | | | | | | | |
| Comparative | Yes | 50 | 142 | 20 | 5 | Yes | 3 | 18.0 | 1.53 | 118 |
| Example 17 | | | | | | | | | | |
| Example 21 | Yes | 100 | 100 | 20 | 5 | Yes | 3 | 18.0 | 1.53 | 118 |
| Example 22 | Yes | 200 | 71 | 20 | 5 | Yes | 3 | 18.0 | 1.53 | 118 |
| Example 23 | Yes | 300 | 57 | 20 | 5 | Yes | 3 | 18.0 | 1.53 | 118 |
| Comparative | No | — | — | 20 | — | Yes | 3.5 | 21.0 | 1.53 | 137 |
| Example 12 | | | | | | | | | | |
| Comparative | Yes | 50 | 142 | 20 | 5 | Yes | 3.5 | 21.0 | 1.53 | 137 |
| Example 18 | | | | | | | | | | |
| Example 24 | Yes | 100 | 100 | 20 | 5 | Yes | 3.5 | 21.0 | 1.53 | 137 |
| Example 25 | Yes | 200 | 71 | 20 | 5 | Yes | 3.5 | 21.0 | 1.53 | 137 |
| Example 26 | Yes | 300 | 57 | 20 | 5 | Yes | 3.5 | 21.0 | 1.53 | 137 |
| Comparative | No | — | — | — | — | Yes | 6.1 | 34.0 | 1.53 | 222 |
| Example 15 | | | | | | | | | | |
| Comparative | Yes | 50 | 142 | 20 | 20 | Yes | 6.1 | 34.0 | 1.53 | 222 |
| Example 19 | | | | | | | | | | |
| Example 27 | Yes | 100 | 100 | 20 | 20 | Yes | 6.1 | 34.0 | 1.53 | 222 |
| Example 28 | Yes | 200 | 71 | 20 | 20 | Yes | 6.1 | 34.0 | 1.53 | 222 |
| Example 29 | Yes | 300 | 57 | 20 | 20 | Yes | 6.1 | 34.0 | 1.53 | 222 |

TABLE 6

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.48 | 99.6 | 91.8 | 4.30 | 12.1 |
| Example 9 | | | | | | |
| Comparative | OK | 0.49 | 99.4 | 92.1 | 4.09 | 9.9 |
| Example 17 | | | | | | |
| Example 21 | OK | 0.50 | 100.7 | 93.8 | 3.83 | 10.4 |
| Example22 | OK | 0.42 | 99.7 | 95.1 | 3.74 | 12.1 |
| Example 23 | OK | 0.46 | 98.60 | 95.5 | 3.70 | 10.2 |
| Comparative | OK | 0.45 | 100.7 | 88.0 | 5.06 | 13.5 |
| Example 12 | | | | | | |
| Comparative | OK | 0.47 | 99.3 | 88.6 | 4.81 | 10.2 |
| Example 18 | | | | | | |
| Example 24 | OK | 0.41 | 100.1 | 91.6 | 4.50 | 13.1 |
| Example 25 | OK | 0.44 | 99.8 | 93.1 | 4.40 | 13.5 |
| Example 26 | OK | 0.45 | 99.9 | 94.1 | 4.35 | 13.0 |
| Comparative | OK | 0.43 | 100.8 | 80.0 | 5.92 | 12.9 |
| Example 15 | | | | | | |
| Comparative | OK | 0.42 | 100.3 | 81.5 | 5.63 | 15.1 |
| Example 19 | | | | | | |
| Example 27 | OK | 0.40 | 100.5 | 87.6 | 5.27 | 13.1 |
| Example 28 | OK | 0.49 | 100.6 | 89.4 | 5.15 | 12.9 |
| Example 29 | OK | 0.46 | 100.1 | 92.1 | 5.09 | 13.5 |

As shown in Table 6, Examples 21 to 29 in which holes were formed at a suitable hole density exhibited excellent or suitable capacity retention, excellent or suitable swelling characteristics and low resistance at the same loading level. Whereas, when the holes were not formed (Comparative Examples 9, 12, and 15), or even when holes were formed, Comparative Examples 17 to 20, having too low a hole density, exhibited low capacity retention, deteriorated swelling characteristics, and high resistance at the same loading level.

Test for Modification of Hole Depth-Using Needle Punching

### EXAMPLES 30 TO 41

A negative electrode having a negative active material layer and an adhesive layer was prepared by the same procedure as in Example 9, except that the obtained product was subjected to needle punching to change hole density, hole pitch, hole depth and hole diameter to as shown in Table 7.

Using the negative electrode, the electrolytes and the separator of Example 9, a rechargeable lithium cell with a current density of 3 mA/cm² was fabricated by the general method.

The cell characteristics of Examples 30 to 41 were measured by the same methods as in Experimental Examples 1 to 5. The results are shown in Table 8. For comparison, the results of Comparative Examples 9, 12, and 15 are also shown in 5 Table 8.

TABLE 7

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer or | density | level | density | thickness |
| | not | (pt/mm²) | (μm) | (μm) | (μm) | not | (mA/cm²) | (mg/cm²) | (g/cm³) | (μm) |
| Comparative | No | — | — | — | — | Yes | 3 | 18.0 | 1.53 | 118 |
| Example 9 | | | | | | | | | | |
| Example 30 | Yes | 200 | 71 | 5 | 20 | Yes | 3 | 18.0 | 1.53 | 118 |
| Example 31 | Yes | 200 | 71 | 10 | 20 | Yes | 3 | 18.0 | 1.53 | 118 |
| Example 32 | Yes | 200 | 71 | 20 | 20 | Yes | 3 | 18.0 | 1.53 | 118 |
| Example 33 | Yes | 200 | 71 | 40 | 20 | Yes | 3 | 18.0 | 1.53 | 118 |
| Comparative | No | — | — | — | — | Yes | 3.5 | 21.0 | 1.53 | 137 |
| Example 12 | | | | | | | | | | |
| Example 34 | Yes | 200 | 71 | 5 | 20 | Yes | 3.5 | 21.0 | 1.53 | 137 |
| Example 35 | Yes | 200 | 71 | 10 | 20 | Yes | 3.5 | 21.0 | 1.53 | 137 |
| Example 36 | Yes | 200 | 71 | 20 | 20 | Yes | 3.5 | 21.0 | 1.53 | 137 |
| Example 37 | Yes | 200 | 71 | 40 | 20 | Yes | 3.5 | 21.0 | 1.53 | 137 |
| Comparative | No | — | — | — | — | Yes | 6.1 | 34.0 | 1.53 | 222 |
| Example 15 | | | | | | | | | | |
| Example 38 | Yes | 200 | 71 | 5 | 20 | Yes | 6.1 | 34.0 | 1.53 | 222 |
| Example 39 | Yes | 200 | 71 | 10 | 20 | Yes | 6.1 | 34.0 | 1.53 | 222 |
| Example 40 | Yes | 200 | 71 | 20 | 20 | Yes | 6.1 | 34.0 | 1.53 | 222 |
| Example 41 | Yes | 200 | 71 | 40 | 20 | Yes | 6.1 | 34.0 | 1.53 | 222 |

TABLE 8

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.48 | 99.6 | 91.8 | 4.30 | 12.1 |
| Example 9 | | | | | | |
| Example 30 | OK | 0.46 | 99.4 | 92.6 | 4.09 | 10.1 |
| Example 31 | OK | 0.47 | 100.8 | 94.8 | 3.83 | — |
| Example 32 | OK | 0.44 | 99.9 | 95.2 | 3.74 | 12.1 |
| Example 33 | OK | 0.40 | 100.1 | 95.4 | 3.70 | 9.9 |
| Comparative | OK | 0.45 | 100.7 | 88.0 | 5.06 | 13.5 |
| Example 12 | | | | | | |
| Example 34 | OK | 0.46 | 99.4 | 88.9 | 4.81 | 12.1 |
| Example 35 | OK | 0.49 | 100.1 | 92.7 | 4.50 | 10.2 |
| Example 36 | OK | 0.49 | 100.5 | 93.2 | 4.40 | 13.5 |
| Example 37 | OK | 0.40 | 99.8 | 93.3 | 4.35 | 10.2 |
| Comparative | OK | 0.43 | 100.8 | 80.0 | 5.92 | 12.9 |
| Example 15 | | | | | | |
| Example 38 | OK | 0.45 | 100.4 | 83.0 | 5.63 | 13.5 |
| Example 39 | OK | 0.41 | 99.2 | 89.2 | 5.27 | 13.0 |
| Example 40 | OK | 0.42 | 99.4 | 89.6 | 5.15 | 12.9 |
| Example 41 | OK | 0.47 | 100.7 | 89.9 | 5.09 | 15.1 |

As shown in Table 8, Examples 30 to 41 in which holes were formed at a suitable hole density exhibited excellent or suitable capacity retention, excellent or suitable swelling characteristics and low resistance at the same loading level. Whereas, when the holes were not formed (Comparative Examples 9, 12 and 15), they exhibited low capacity retention, deteriorated swelling characteristics, and high resistance at the same loading level.

Test for Modification of Hole Depth-Using Laser Processing

### EXAMPLES 42 TO 51 AND REFERENCE EXAMPLES 4 to 9

A negative electrode having a negative active material layer and an adhesive layer was prepared by the same procedure as in Example 9, except that the obtained product was subjected to laser processing utilizing a WS-FLEX IR Femtosecond laser work station to change hole density, hole pitch, hole depth and hole diameter into as shown in Table 9.

Using the negative electrode, the electrolyte, and the separator of Example 9, a rechargeable lithium cell with a current density of 3 mA/cm² was fabricated by the general method.

The cell characteristics of Examples 42 to 53 and Reference Examples 4 to 9 were measured by the same methods as in Experimental Examples 1 to 5. The results are shown in Table 10. For comparison, the results of Examples 22 and 25, and Comparative Examples 9, 12, and 15 are also shown in Table 10.

TABLE 9

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer or | density | level | density | thickness |
| | not | (pt/mm²) | (μm) | (μm) | (μm) | not | (mA/cm²) | (mg/cm²) | (g/cm³) | (μm) |
| Comparative | No | — | — | — | — | Yes | 3 | 18.0 | 1.53 | 118 |
| Example 9 | | | | | | | | | | |
| Reference | Yes | 200 | 71 | 3 | 5 | Yes | 3 | 18.0 | 1.53 | 118 |
| Example 4 | | | | | | | | | | |
| Example 42 | Yes | 200 | 71 | 5 | 5 | Yes | 3 | 18.0 | 1.53 | 118 |
| Example 43 | Yes | 200 | 71 | 10 | 5 | Yes | 3 | 18.0 | 1.53 | 118 |
| Example 22 | Yes | 200 | 71 | 20 | 5 | Yes | 3 | 18.0 | 1.53 | 118 |
| Example 44 | Yes | 200 | 71 | 40 | 5 | Yes | 3 | 18.0 | 1.53 | 118 |
| Reference | Yes | 200 | 71 | 50 | 5 | Yes | 3 | 18.0 | 1.53 | 118 |
| Example 5 | | | | | | | | | | |
| Comparative | No | — | — | — | — | Yes | 3.5 | 21.0 | 1.53 | 137 |
| Example 12 | | | | | | | | | | |
| Reference | Yes | 200 | 71 | 3 | 5 | Yes | 3.5 | 21.0 | 1.53 | 137 |
| Example 6 | | | | | | | | | | |
| Example 45 | Yes | 200 | 71 | 5 | 5 | Yes | 3.5 | 21.0 | 1.53 | 137 |
| Example 46 | Yes | 200 | 71 | 10 | 5 | Yes | 3.5 | 21.0 | 1.53 | 137 |
| Example 25 | Yes | 200 | 71 | 20 | 5 | Yes | 3.5 | 21.0 | 1.53 | 137 |
| Example 47 | Yes | 200 | 71 | 40 | 5 | Yes | 3.5 | 21.0 | 1.53 | 137 |
| Reference | Yes | 200 | 71 | 50 | 5 | Yes | 3.5 | 21.0 | 1.53 | 137 |
| Example 7 | | | | | | | | | | |
| Comparative | No | — | — | — | — | Yes | 6.1 | 34.0 | 1.53 | 222 |
| Example 15 | | | | | | | | | | |
| Reference | Yes | 200 | 71 | 3 | 5 | Yes | 6.1 | 34.0 | 1.53 | 222 |
| Example 8 | | | | | | | | | | |
| Example 48 | Yes | 200 | 71 | 5 | 5 | Yes | 6.1 | 34.0 | 1.53 | 222 |
| Example 49 | Yes | 200 | 71 | 10 | 5 | Yes | 6.1 | 34.0 | 1.53 | 222 |
| Example 50 | Yes | 200 | 71 | 20 | 5 | Yes | 6.1 | 34.0 | 1.53 | 222 |
| Example 51 | Yes | 200 | 71 | 40 | 5 | Yes | 6.1 | 34.0 | 1.53 | 222 |
| Reference | Yes | 200 | 71 | 50 | 5 | Yes | 6.1 | 34.0 | 1.53 | 222 |
| Example 9 | | | | | | | | | | |

TABLE 10

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.48 | 99.6 | 91.8 | 4.30 | 12.1 |
| Example 9 | | | | | | |
| Reference | OK | 0.45 | 99.6 | 91.8 | 4.30 | 12.7 |
| Example 4 | | | | | | |
| Example 42 | OK | 0.42 | 99.3 | 92.3 | 4.09 | 12.9 |
| Example 43 | OK | 0.47 | 99.9 | 94.5 | 3.83 | 13.5 |
| Example 22 | OK | 0.42 | 99.9 | 94.9 | 3.74 | 12.1 |
| Example 44 | OK | 0.42 | 100.4 | 95.5 | 3.70 | 10.1 |
| Reference | NG | 1.25 | 98.5 | — | — | — |
| Example 5 | | | | | | |
| Comparative | OK | 0.45 | 100.7 | 88.0 | 5.06 | 13.5 |
| Example 12 | | | | | | |
| Reference | OK | 0.41 | 100.10 | 87.9 | 5.08 | 14.8 |
| Example 6 | | | | | | |
| Example 45 | OK | 0.43 | 99.4 | 90.5 | 4.83 | 13.5 |
| Example 46 | OK | 0.48 | 100.4 | 91.0 | 5.66 | 14.6 |
| Example 25 | OK | 0.43 | 100.8 | 91.4 | 5.65 | 15.1 |
| Example 47 | OK | 0.48 | 99.8 | 91.9 | 5.61 | 13.5 |
| Reference | NG | 1.31 | 98.10 | — | — | — |
| Example 7 | | | | | | |
| Comparative | OK | 0.43 | 100.8 | 80.0 | 5.92 | 12.9 |
| Example 15 | | | | | | |
| Reference | OK | 0.42 | 99.60 | 80.1 | 5.90 | 14.1 |
| Example 8 | | | | | | |
| Example 48 | OK | 0.46 | 99.3 | 82.5 | 5.60 | 14.4 |
| Example 49 | OK | 0.45 | 100.3 | 82.9 | 5.25 | 10.9 |
| Example 50 | OK | 0.40 | 100.2 | 83.3 | 5.13 | 13.8 |
| Example 51 | OK | 0.44 | 100.20 | 83.7 | 5.07 | 14.0 |
| Reference | NG | 1.33 | 98.1 | — | — | — |
| Example 9 | | | | | | |

As shown in Table 10, Examples 42 to 51 in which holes were formed at a suitable hole density exhibited excellent or suitable capacity retention, excellent or suitable swelling characteristics and low resistance at the same loading level. Whereas, when the holes were not formed (Comparative Examples 9, 12, and 15), they exhibited low capacity retention, deteriorated swelling characteristics, and high resistance at the same loading level. Or, Reference Examples 5, 7, and 9 in which the hole was formed too deep even when the holes were formed, exhibited too weak an adherence, causing detachment.

Test for Modification of Hole Diameter-Using Needle Punching

### EXAMPLES 52 TO 60 AND REFERENCE EXAMPLES 10 to 12

A negative electrode having a negative active material layer and an adhesive layer was prepared by the same procedure as in Example 9, except that the obtained product was subjected to needle punching to change hole density, hole pitch, hole depth and hole diameter to as shown in Table 11.

Using the negative electrode, the electrolyte, and the separator of Example 9, a rechargeable lithium cell with a current density shown in Table 11 was fabricated by the general method.

The cell characteristics of Examples 52 to 60 and Reference Examples 10 to 12 were measured by the same methods as in Experimental Examples 1 to 5. The results are shown in Table 12. For comparison, the results according to Comparative Examples 9, 12, and 15 are also shown in Table 12.

TABLE 11

| | | | | | | Presence | | | | Active |
|---|---|---|---|---|---|---|---|---|---|---|
| | | | | | | of | | | Active | material |
| | Presence | Hole | Hole | Hole | Hole | adhesive | Current | Loading | mass | layer |
| | of hole or | density | pitch | depth | diameter | layer or | density | level | density | thickness |
| | not | (pt/ mm²) | (μm) | (μm) | (μm) | not | (mA/cm²) | (mg/cm²) | (g/ cm³) | (μm) |
| Comparative | No | — | — | — | — | Yes | 3 | 18.0 | 1.53 | 118 |
| Example 9 | | | | | | | | | | |
| Example 52 | Yes | 200 | 71 | 5 | 3 | Yes | 3 | 18.0 | 1.53 | 118 |
| Example 53 | Yes | 200 | 71 | 15 | 10 | Yes | 3 | 18.0 | 1.53 | 118 |
| Example 54 | Yes | 200 | 71 | 20 | 35 | Yes | 3 | 18.0 | 1.53 | 118 |
| Reference | Yes | 200 | 71 | 20 | 40 | Yes | 3 | 18.0 | 1.53 | 118 |
| Example 10 | | | | | | | | | | |
| Comparative | No | — | — | — | — | Yes | 3.5 | 21.0 | 1.53 | 137 |
| Example 12 | | | | | | | | | | |
| Example 55 | Yes | 200 | 71 | 5 | 3 | Yes | 3.5 | 21.0 | 1.53 | 137 |
| Example 56 | Yes | 200 | 71 | 15 | 10 | Yes | 3.5 | 21.0 | 1.53 | 137 |
| Example 57 | Yes | 200 | 71 | 20 | 30 | Yes | 3.5 | 21.0 | 1.53 | 137 |
| Reference | Yes | 200 | 71 | 20 | 40 | Yes | 3.5 | 21.0 | 1.53 | 137 |
| Example 11 | | | | | | | | | | |
| Comparative | No | — | — | — | — | Yes | 6.1 | 34.0 | 1.53 | 222 |
| Example 15 | | | | | | | | | | |
| Example 58 | Yes | 200 | 71 | 5 | 3 | Yes | 6.1 | 34.0 | 1.53 | 222 |
| Example 59 | Yes | 200 | 71 | 15 | 10 | Yes | 6.1 | 34.0 | 1.53 | 222 |
| Example 60 | Yes | 200 | 71 | 20 | 35 | Yes | 6.1 | 34.0 | 1.53 | 222 |
| Reference | Yes | 200 | 71 | 20 | 40 | Yes | 6.1 | 34.0 | 1.53 | 222 |
| Example 12 | | | | | | | | | | |

TABLE 12

| | Adherence | | Cell | Capacity | | |
|---|---|---|---|---|---|---|
| | Degree of | Amount of | capacity | retention | Swelling | Resistance |
| | adhesion | detachment (%) | (mAh) | (%) | (%) | (Ω) |
| Comparative | OK | 0.43 | 99.6 | 91.8 | 4.30 | 12.1 |
| Example 9 | | | | | | |
| Example 52 | OK | 0.50 | 100.7 | 95.0 | 3.71 | 12.9 |
| Example 53 | OK | 0.48 | 100.7 | 94.9 | 3.73 | 12.7 |
| Example 54 | OK | 0.41 | 100.1 | 95.2 | 3.69 | 12.1 |
| Reference | Detachment | 1.14 | 98.6 | — | — | — |
| Example 10 | | | | | | |
| Comparative | OK | 0.45 | 100.7 | 880.0 | 5.06 | 13.5 |
| Example 12 | | | | | | |
| Example 55 | OK | 0.48 | 99.9 | 90.4 | 3.14 | 12.7 |
| Example 56 | OK | 0.48 | 99.4 | 90.7 | 3.12 | 12.8 |
| Example 57 | OK | 0.43 | 99.5 | 91.2 | 3.10 | 14.1 |
| Reference | Detachment | 1.11 | 99.2 | — | — | — |
| Example 11 | | | | | | |
| Comparative | OK | 0.43 | 100.8 | 80.0 | 5.92 | 12.9 |
| Example 15 | | | | | | |
| Example 58 | OK | 0.48 | 100.5 | 82.8 | 3.71 | 12.9 |
| Example 59 | OK | 0.45 | 100.9 | 82.7 | 3.73 | 12.7 |
| Example 60 | OK | 0.47 | 99.8 | 83.0 | 3.69 | 12.1 |
| Reference | Detachment | 1.26 | 98.9 | — | — | — |
| Example 12 | | | | | | |

As shown in Table 12, Examples 52 to 60 in which the holes were formed at the desired or suitable hole density and the desired or suitable hole diameter, exhibited excellent or suitable capacity retention, excellent or suitable swelling characteristic and low resistance at the same loading level. Whereas, Comparative Examples 9, 12, and 15 in which holes were not performed, exhibited low capacity retention. In some embodiments, even though the holes were formed, Reference Examples 10 to 12 in which holes were formed at too large a hole diameter, had too weak adhesion to occur detachment.

While this disclosure has been described in connection with what is presently considered to be practical example embodiments, it is to be understood that the present disclosure is not limited to the disclosed embodiments, but, on the contrary, is intended to cover one or more suitable modifications and equivalent arrangements included within the spirit and scope of the appended claims, and equivalents thereof.

As used herein, the term “substantially,” “about,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

As used herein, the terms “use,” “using,” and “used” may be considered synonymous with the terms “utilize,” “utilizing,” and “utilized,” respectively.

The use of “may” when describing embodiments of the present disclosure refers to “one or more embodiments of the present disclosure.”

As used herein, the singular forms “a”, “an” and “the” are intended to include the plural forms as well, unless the context clearly indicates otherwise.

In the present disclosure, when particles, holes, openings, pores, etc., are spherical, circular, etc., “size” or “diameter” indicates a particle, hole, pore, or opening diameter or an average particle, hole, pore, or opening diameter, and when the particles, holes, openings, pores, etc., are non-spherical, the “size” or “diameter” indicates a major axis length or an average major axis length. That is, when particles, holes, openings, etc., are spherical, “diameter” indicates a particle, hole, pore, or opening diameter or an average particle diameter, and when the particles, pores, holes, openings, etc., are non-spherical, the “diameter” indicates a major axis length or an average major axis length. The size or diameter of the particles, pores, holes, openings, etc., may be measured utilizing a scanning electron microscope or a suitable size analyzer.

As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol% in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As used herein, expressions such as “at least one of”, “one of”, and “selected from”, when preceding a list of elements, modify the entire list of elements and do not modify the individual elements of the list. For example, “at least one of a, b or c”, “at least one selected from a, b and c”, etc., may indicate only a, only b, only c, both (e.g., simultaneously) a and b, both (e.g., simultaneously) a and c, both (e.g., simultaneously) b and c, all of a, b, and c, or variations thereof.

The vehicle, a battery management system (BMS) device, and/or any other relevant devices or components according to embodiments of the present invention described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the present disclosure.

What is claimed is:

1. A negative electrode for a rechargeable lithium battery, the negative electrode comprising:
a current collector; and
a negative active material layer on the current collector,
wherein the negative active material layer comprises a plurality of holes at a hole density of about 90 pt/mm² or more.

2. The negative electrode for the rechargeable lithium battery of claim 1, wherein the hole density is about 90 pt/mm²to about 625 pt/mm².

3. The negative electrode for the rechargeable lithium battery of claim 1, wherein the plurality of holes has a depth of about 5 μm to about 40 μm.

4. The negative electrode for the rechargeable lithium battery of claim 1, wherein the plurality of holes has a depth of about 5 μm to about 20 μm.

5. The negative electrode for the rechargeable lithium battery of claim 1, wherein the negative active material layer comprises the plurality of holes at a pitch of about 100 μm or less.

6. The negative electrode for the rechargeable lithium battery of claim 1, wherein the negative active material layer comprises the plurality of holes at a pitch of about 40 μm to about 100 μm.

7. The negative electrode for the rechargeable lithium battery of claim 1, wherein the negative electrode further comprises an adhesive layer comprising a plurality of holes on the negative active material layer.

8. The negative electrode for the rechargeable lithium battery of claim 7, wherein the adhesive layer has a thickness of about 1 μm to about 5 μm.

9. The negative electrode for the rechargeable lithium battery of claim 6, wherein the negative electrode further comprises an adhesive layer, and wherein the adhesive layer comprises a vinyl-based or an acryl-based polymer, polyvinyl alcohol, a fluorine-based polymer, or a combination thereof.

10. The negative electrode for the rechargeable lithium battery of claim 1, wherein the negative electrode has a loading level of about 15 mg/cm² or more.

11. A rechargeable lithium battery comprising:
the negative electrode of claim 1;
a positive electrode; and
an electrolyte.
